(19) United States
(12) Patent Application Publication
(10) Pub. No.: US 2019/0100168 A1
(43) Pub. Date: Apr. 4, 2019

(54) VEHICLE SENSOR CLEANING

(71) Applicant: Ford Global Technologies, LLC, Dearborn, MI (US)

(72) Inventors: Venkatesh Krishnan, Canton, MI (US); Segundo Baldovino, Novi, MI (US); Andre Sykula, Sterling Heights, MI (US)

(73) Assignee: Ford Global Technologies, LLC, Dearborn, MI (US)

(21) Appl. No.: 15/724,884

(22) Filed: Oct. 4, 2017

(51) Int. Cl. B60S 1/08; B60S 1/56; B60S 1/48; B60S 1/54; G02B 27/00; G06T 7/00

(52) U.S. Cl. CPC B60S 1/0848; B60S 1/56; G06T 7/0002; B60S 1/542; G02B 27/0006; B60S 1/485

(57) ABSTRACT

A system includes a first computer including a processor and a memory. The memory stores instructions executable by the processor to receive a message from a second computer indicating one of a cleaning command specifying a sensor and a precipitation condition. If the message does not indicate a precipitation condition, the instructions include instructions to actuate a reservoir pump to clean the sensor specified in the cleaning command. If the message does indicate the precipitation condition, the instructions further include instructions to actuate a windshield wiper.

### BACKGROUND

Vehicles can include sensors to collect data of a surrounding environment. The sensors can be placed on various parts of the vehicle, e.g., a vehicle roof, a vehicle hood, a rear vehicle door, etc. However, the sensors may become dirty during operation of the vehicle. It is a problem to effectively clean sensors and/or sensor lenses or covers, especially when sensor data and/or environmental conditions around a vehicle can be changing and changes can affect sensor operation.

### BRIEF DESCRIPTION OF THE DRAWINGS

FIG. 1 is a block diagram of an example system for cleaning a vehicle.

FIG. 2 is an isometric view of the vehicle including sensors.

FIG. 3 is a block diagram of a computer communicating with vehicle components.

FIG. 4 illustrates an example process for cleaning the vehicle.

### DETAILED DESCRIPTION

A system includes a first computer including a processor and a memory, the memory storing instructions executable by the processor to receive a message from a second computer indicating one of a cleaning command specifying a sensor and a precipitation condition. If the message does not indicate a precipitation condition, the instructions include instructions to actuate a reservoir pump to clean the sensor specified in the cleaning command. If the message does indicate the precipitation condition, the instructions include instructions to actuate a windshield wiper.

The instructions can further include instructions to open a valve in fluid communication with the reservoir pump for a period of time specified in the cleaning command.

The instructions can further include instructions to open a valve in fluid communication with an air compressor for a period of time specified in the cleaning command.

The instructions can further include instructions to, upon actuating the windshield wiper, actuate an air compressor to direct air to a sensor.

The cleaning command can include instructions to actuate the reservoir pump for each of a plurality of specified sensors to spray a fluid onto the specified sensors.

The instructions can further include instructions to, upon completing the cleaning command, send a message to the second computer to determine whether the specified sensor is clean.

The instructions can further include instructions to, upon actuating the windshield wiper, send a message to the second computer to determine whether the precipitation condition has ended.

The instructions can further include instructions to deactivate the windshield wiper upon receiving a second message from the second computer indicating that the precipitation condition has ended.

The cleaning command can include instructions to actuate the reservoir pump on a first sensor, actuate an air compressor on the first sensor, actuate the reservoir pump on a second sensor, and actuate the air compressor on the second sensor.

The instructions can further include instructions to open a plurality of air manifolds, each air manifold directed to one of a plurality of sensors, and to actuate an air compressor to blow air through the plurality of air manifolds.

A system includes a windshield wiper, a rain sensor, a reservoir pump, means for receiving a message indicating one of a cleaning command specifying a sensor and a precipitation condition, means for actuating the reservoir pump and the windshield wiper to clean the sensor specified in the cleaning command if the message does not indicate a precipitation condition, and means for actuating the windshield wiper if the message does indicate the precipitation condition.

The system can further include means to open a valve in fluid communication with the reservoir pump for a period of time specified in the cleaning command.

The system can further include means to open a valve in fluid communication with an air compressor for a period of time specified in the cleaning command.

The system can further include means to, upon actuating the windshield wiper, actuate an air compressor to direct air to a sensor.

The cleaning command can include instructions to actuate the reservoir pump for each of a plurality of specified sensors to spray a fluid onto the specified sensors.

The system can further include means for, upon completing the cleaning command, sending a message to determine whether the specified sensor is clean.

The system can further include means for, upon actuating the windshield wiper, sending a message to determine whether the precipitation condition has ended.

The system can further include means for deactivating the windshield wiper upon receiving a second message indicating that the precipitation condition has ended.

The cleaning command can further include instructions to actuate the reservoir pump on a first sensor, actuate an air compressor on the first sensor, actuate the reservoir pump on a second sensor, and actuate the air compressor on the second sensor.

A method includes receiving a message from a second computer indicating one of a cleaning command specifying a sensor and a precipitation condition, if the message does not indicate a precipitation condition, actuating a reservoir pump to clean the sensor specified in the cleaning command, and, if the message does indicate the precipitation condition, actuating a windshield wiper.

By using the first computer and the second computer, the system can selectively actuate components to clean the sensors and the windshield based on the quality of the sensor data and a precipitation condition. Furthermore, the first computer can actuate vehicle components based on instructions from the second computer, and the second computer can generate the instructions upon request from the first computer, allowing the first computer and the second computer to conserve overall computing resources.

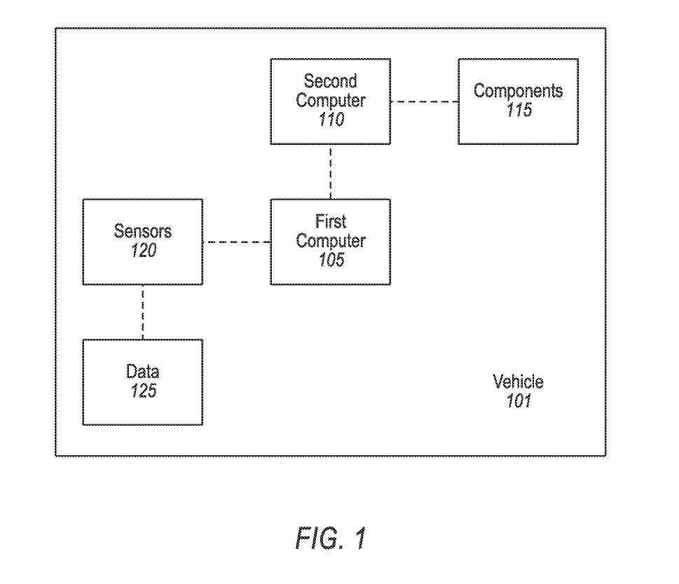

FIG. 1 illustrates an example system 100 for operating a vehicle 101. A first computer 105 in the vehicle 101 is programmed to actuate one or more vehicle components 115. A second computer 110 in the vehicle 101 is programmed to receive collected data 125 from one or more sensors 120. For example, vehicle 101 data 125 may include a location of the vehicle 101, data about an environment around a vehicle, data about an object outside the vehicle such as another vehicle, etc. A vehicle 101 location is typically provided in a conventional form, e.g., geo-coordinates such as latitude and longitude coordinates obtained via a navigation system that uses the Global Positioning System (GPS). Further examples of data 125 can include measurements of vehicle 101 systems and components, e.g., a vehicle 101 velocity, a vehicle 101 trajectory, etc. Collecting data 125 and actuating components 115 with one of the computers 105, 110 can be require additional computing resources. By using two computers 105, 110, one for actuating the components 115 and another for processing collected data 125 from sensors 120, each computer 105, 110 can direct resources to specific computing tasks. Thus, overall processing of the computers 105, 110 is reduced and/or cleaning and/or operation of sensors 120 is made more efficient.

The computers 105, 110 are generally programmed for communications on a vehicle 101 network, e.g., including a communications bus, as is known. Via the network, bus, and/or other wired or wireless mechanisms (e.g., a wired or wireless local area network in the vehicle 101), the computers 105, 110 may transmit messages to various devices in a vehicle 101 and/or receive messages from the various devices, e.g., controllers, actuators, sensors, etc., including sensors 120. Alternatively or additionally, in cases where the computers 105, 110 actually comprise multiple devices, the vehicle network may be used for communications between devices represented as the computer 105 in this disclosure. In addition, the computers 105, 110 may be programmed for communicating with a network which may include various wired and/or wireless networking technologies, e.g., cellular, Bluetooth®, Bluetooth® Low Energy (BLE), wired and/or wireless packet networks, etc.

The vehicle 101 includes a plurality of vehicle components 115. Each vehicle component 115 includes one or more hardware components adapted to perform a mechanical function or operation—such as moving the vehicle, slowing or stopping the vehicle, steering the vehicle, etc. Non-limiting examples of components 115 include a propulsion component (that includes, e.g., an internal combustion engine and/or an electric motor, etc.), a transmission component, a steering component (e.g., that may include one or more of a steering wheel, a steering rack, etc.), a brake component, a park assist component, an adaptive cruise control component, an adaptive steering component, a movable seat, and the like.

Sensors 120 may include a variety of devices. For example, as is known, various controllers in a vehicle 101 may operate as sensors 120 to provide data 125 via the vehicle 101 network or bus, e.g., data 125 relating to vehicle speed, acceleration, position, subsystem and/or component status, etc. Further, other sensors 120 could include cameras, motion detectors, etc., i.e., sensors 120 to provide data 125 for evaluating a location of a target, projecting a path of a target, evaluating a location of a roadway lane, etc. The sensors 120 could also include short range radar, long range radar, LIDAR, and/or ultrasonic transducers.

Collected data 125 may include a variety of data collected in a vehicle 101. Examples of collected data 125 are provided above, and moreover, data 125 are generally collected using one or more sensors 120, and may additionally include data calculated therefrom in the computer 105, and/or at the server 130. In general, collected data 125 may include any data that may be gathered by the sensors 120 and/or computed from such data.

When the computers 105, 110 operate the vehicle 101, the vehicle 101 is an “autonomous” vehicle 101. For purposes of this disclosure, the term “autonomous vehicle” is used to refer to a vehicle 101 operating in a fully autonomous mode. A fully autonomous mode is defined as one in which each of vehicle 101 propulsion (typically via a powertrain including an electric motor and/or internal combustion engine), braking, and steering are controlled by the computers 105, 110. A semi-autonomous mode is one in which at least one of vehicle 101 propulsion (typically via a powertrain including an electric motor and/or internal combustion engine), braking, and steering are controlled at least partly by the computers 105, 110 as opposed to a human operator.

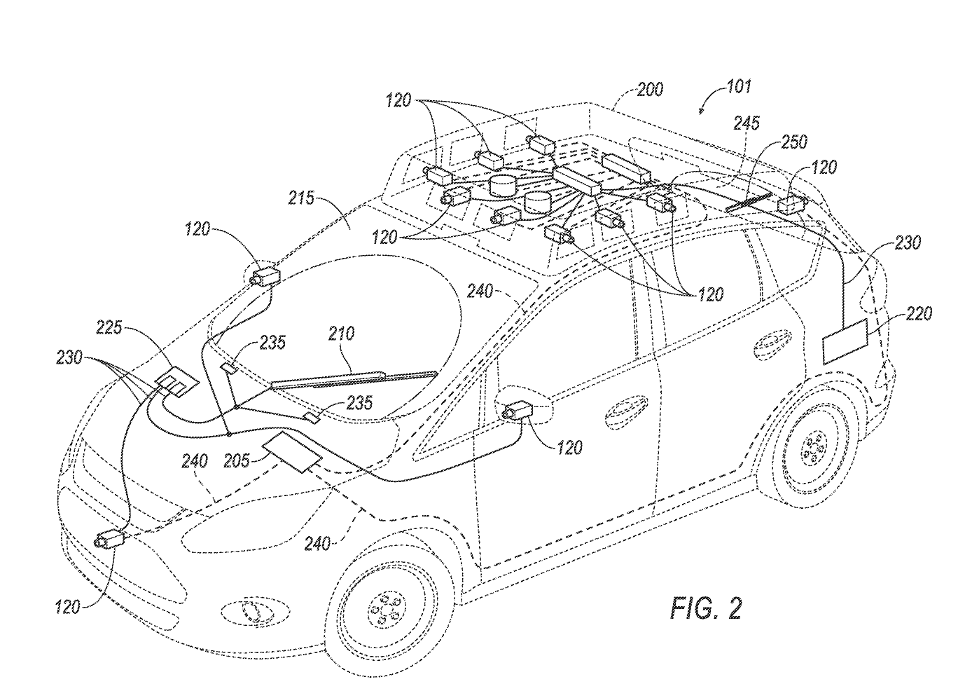

FIG. 2 illustrates an example vehicle 101. The vehicle 101 can include a sensor block 200. The sensor block 200 can include a plurality of sensors 120, including one or more cameras 120 and lidars 120. The second computer 110 can collect data 125 from the sensors 120 to operate the vehicle 101.

The sensors 120 can be occluded with occluding matter, e.g., dirt, grime, etc. The second computer 110 can determine that the sensors 120 require cleaning to remove the occluding matter. The second computer 110 can capture an image of an area around the vehicle 101 and, using known image analysis techniques, determine whether the image is occluded from occluding matter on the sensor 120. For example, as described below, the second computer 110 can determine a light transmittance percentage received by the sensor 120, and when the light transmittance percentage is below a light transmittance threshold, the second computer 110 can determine that the sensor 120 is occluded.

The vehicle 101 can include an air compressor 205. The air compressor 205 can move air toward an intended target, e.g., one of the sensors 120. The air compressor 205 can move air through air manifolds 240 to move the air to the sensors 120. Each air manifold 240 can be directed toward one of the sensors 10. The first computer 105 can be programmed to open the air manifolds 240. For example, the air manifolds 240 can include valves (not shown) that the first computer 105, in communication with actuators thereof such as are known, can instruct to open, allowing air to move through the air manifolds 240 to the sensors 120.

The vehicle 101 can include a windshield wiper 210. The windshield wiper 210 can remove water from a windshield 215. The first computer 105 can actuate the windshield wiper 210 when the second computer 110 detects a precipitation condition. The first computer 105 can actuate the windshield wiper 210 until receiving a message from the second computer 110 indicating that the precipitation condition has ended.

The vehicle 101 can include a fluid reservoir 220. The fluid reservoir 220 can contain washer fluid to spray onto the sensors 120. The fluid reservoir 220 can be in fluid communication with a reservoir pump 225. The reservoir pump 225 can direct the washer fluid from the fluid reservoir 220 through fluid lines 230 to spray the washer fluid onto, e.g., the sensors 120, the windshield 215, etc. The reservoir pump 225 can spray the washer fluid through sprayers 235 onto the windshield 215. The fluid lines 230 can include valves (not shown) that the first computer 105 can actuate to move fluid from the fluid reservoir 220 through the fluid lines 230 to the windshield 215, the rear window 245, and/or the sensors 120.

The vehicle 101 can include a rear window 245 and a rear wiper 250. The rear window 245 allows an occupant to view objects behind the vehicle 101. The rear wiper 250 removes fluid and dirt from the rear window 245. The first computer 105 can actuate the rear wiper 250 to move along the rear window 245 to clean the rear window 245. The reservoir pump 225 can spray washer fluid onto the rear window 245, and the rear wiper 250 can remove the fluid.

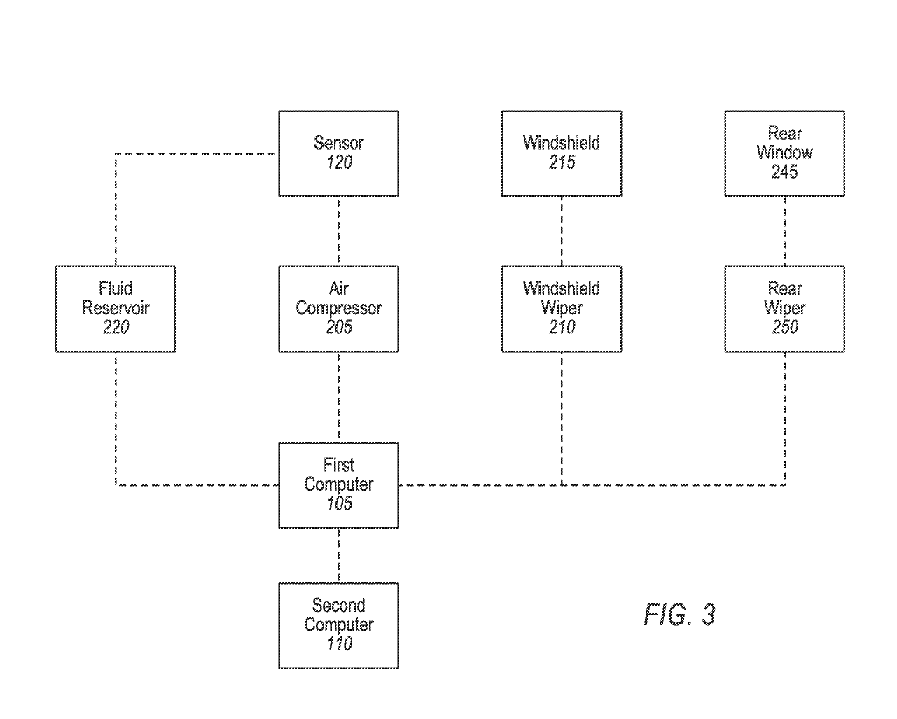

FIG. 3 illustrates the first computer 105 and the second computer 110 communicating with the vehicle components 115. The first computer 105 can be programmed to actuate the reservoir pump 225 and the air compressor 205. The first computer 105 can receive instructions from the second computer 110. The first computer 105 can execute the instructions to actuate the components 115, e.g., the air compressor 205, the reservoir pump 225, the windshield wiper 210, the rear wiper 250, etc.

The second computer 110 can instruct one or more sensors 120 to collect data 125 and send a message to the first computer 105 based on the data 125. The second computer 110 can further generate instructions executable by the first computer 105 to actuate one or more components 115 to operate the vehicle 101.

The second computer 110 can determine whether the sensors 120 require cleaning. The second computer 110 can, using known diagnostic techniques, determine whether the data 125 from the sensors 120 indicates that the sensors 120 are occluded and require cleaning to remove the occluding material. For example, the second computer 110 can collect data 125 with the sensors 120 and determine a quality of the data 125, using known data 125 quality determining techniques, such as determining a light transmittance percentage, i.e., an amount of light received by the sensor 120 divided by a maximum amount of light receivable by the sensor 120, for the sensors 120, where the light transmittance percentage decreases when the sensor 120 is occluded with occluding material. The second computer 110 can determine that the sensors 120 require cleaning when the quality of the data 125 is below a quality threshold. The “quality” of the data 125 is a measure of the reliability of the data 125 collected by the sensor 120, and when the light transmittance percentage decreases, the amount of data 125 and the reliability of the data 125 collected by the sensor 120 can decrease. For example, if the light transmittance percentage of the sensors 120 is below a transmittance threshold, e.g., 80% transmittance, the second computer 110 can determine that the sensors 120 require cleaning.

The second computer 110 can be programmed to detect a precipitation condition, e.g., rain, snow, etc. The second computer 110 can actuate a sensor 120 that is programmed to detect precipitation and collect precipitation data 125. The second computer 110 can, upon receiving the data 125, determine whether there is a precipitation condition using known precipitation-detecting algorithms. For example, the second computer 110 can detect the precipitation condition when a sensor 120 receives light from an infrared light emitter emitting light onto the windshield 215, and a brightness of the received light is below a brightness threshold. During a precipitation condition, water on the windshield 215 can scatter the emitted infrared light away from the windshield 215, and the sensor 120 receiving the emitted infrared light thus receives less light than was emitted by the infrared light emitter. For example, the second computer 110 can instruct the infrared light emitter to emit a specified amount of light, and a rain sensor 120 can determine an amount of received infrared light. Precipitation can cause the infrared light to escape the vehicle 101, reducing the amount of infrared light received by the rain sensor 120. The second computer 110 can compare the amount of received infrared light to the amount of emitted infrared light to determine a percentage of infrared light received by the rain sensor 120. When the percentage of infrared light received is below a predetermined threshold, e.g., 80%, the second computer 110 can determine that a precipitation condition is occurring.

The second computer 110 can be programmed to generate one or more cleaning commands for the first computer 105. By generating cleaning commands for the first computer 105, the second computer 110 can use computing resources on other operations of the vehicle 101, e.g., collecting data 125 from sensors 120, operating a propulsion 115, operating a steering 115, etc. Furthermore, the first computer 105 can focus computing resources on following the cleaning commands, and overall computing resources of the first computer 105 and the second computer 110 can be conserved. If the second computer 110 determines that there is no precipitation condition, the second computer 110 can generate commands indicating actuation of the reservoir pump 225 and the air compressor 205 for each sensor 120. For example, the cleaning commands can include commands to actuate the reservoir pump 225 for 5 seconds to spray washer fluid onto a sensor 120, and then to actuate the air compressor 205 for 5 seconds to remove the washer fluid and the occluding material from the sensor 120. The cleaning commands can include commands to actuate the reservoir pump 225 and the air compressor 205 for each successive sensor 120 in a predetermined sequence, e.g., actuate the reservoir pump 225 to spray washer fluid onto a first sensor 120, actuate the air compressor 205 to direct air to the first sensor 120, actuate the reservoir pump 225 to spray washer fluid on a second sensor 120, and actuate the air compressor 205 to direct air to the second sensor 120.

The second computer 110 can be programmed to instruct the first computer 105 to actuate the windshield wiper 210 and/or the rear wiper 250. If the second computer 110 detects a precipitation condition, then the sensors 120 may not require washer fluid from the reservoir pump 225 to remove the occluding material. The second computer 110 can instruct the first computer 105 to actuate the air compressor 205 to remove rain water and/or occluding material from the windshield 215 and/or the rear window 245. The second computer 110 can further instruct the first computer 105 to actuate the windshield wiper 210 to remove rain water from the windshield 215 and/or the rear wiper 250 to remove rain water from the rear window 245.

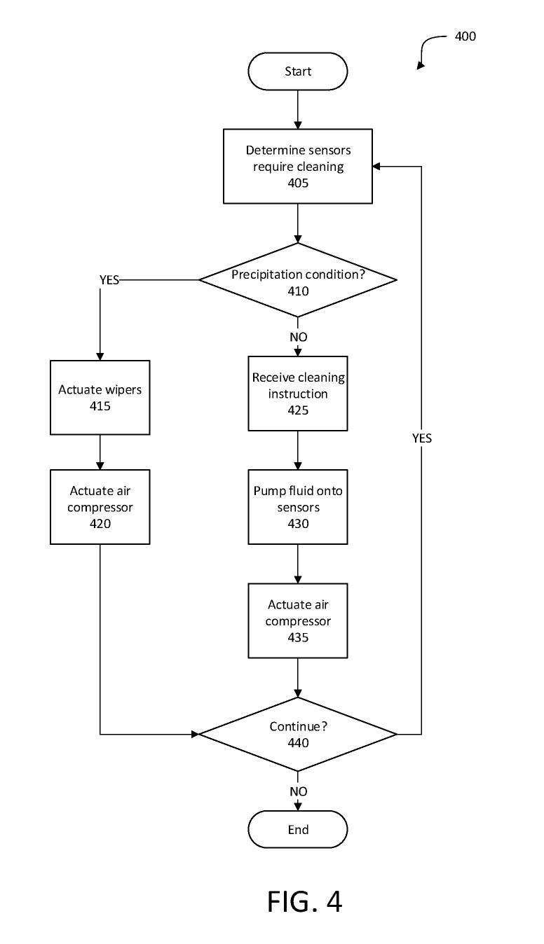

FIG. 4 illustrates an example process 400 for cleaning the sensors 120. The process 400 begins in a block 405, in which the second computer 110 determines whether the sensors 120 require cleaning. As described above, the second computer 110 uses known data 125 quality determining techniques to determine whether the sensors 120 are occluded and require cleaning. For example, the second computer 110 can determine a light transmittance percentage for the sensors 120, and when the light transmittance percentage is below a threshold (e.g., 80%), the second computer 110 can determine that the sensors 120 require cleaning.

Next, in a block 410, the second computer 110 determines whether there is a precipitation condition. The second computer 110 can actuate one or more sensors 120 to collect data 125 about precipitation, e.g., a rain sensor, to detect the precipitation condition. As described above, the second computer 110 can use known precipitation-sensing techniques to detect the precipitation condition. For example, the second computer 110 can compare an amount of infrared light emitted from an infrared light emitter to an amount of infrared light received by a rain sensor 120 to determine a percentage of infrared light received. If the percentage of infrared light receive dis below a predetermined threshold (e.g., 80%), then the second computer 110 can determine that there is a precipitation condition. If the second computer 110 detects the precipitation condition, the process 400 continues in a block 415. Otherwise, the process 400 continues in a block 425.

In the block 415, the first computer 105 actuates the windshield wiper 210 and the rear wiper 250. The first computer 105 can instruct the windshield wiper 210 and the rear wiper 250 to remove water from the windshield 215 and the rear window 245.

Next, in a block 420, the first computer 105 actuates the air compressor 205 to move air to the sensors 120. The first computer 105 can open the air valves (not shown), blowing air from the air compressor 205 through the air manifolds 240 to dry the sensors 120.

In the block 425, the first computer 105 receives a cleaning command from the second computer 110. As described above, based on the sensors 120 that require cleaning, the cleaning command can include specified actuation of the air compressor 205 and the reservoir pump 225 to clean the sensors 120.

Next, in a block 430, the first computer 105 actuates the fluid reservoir pump 225 to spray washer fluid from the fluid reservoir 220 onto one of the sensors 120. The first computer 105 can actuate the fluid reservoir pump 225 for a period of time specified in the cleaning command, e.g., 5 seconds.

Next, in a block 435, the first computer 105 actuates the air compressor 205 to blow air onto the sensor 120 to remove the washer fluid. The first computer 105 can actuate the air compressor 205 for a period of time specified in the cleaning command, e.g., 5 seconds.

Next, in a block 440, the first computer 105 determines whether to continue the process 400. For example, the first computer 105 can determine to continue the process 400 when the vehicle 101 is in motion and following a predetermined route. Alternatively, the first computer 105 can determine not to continue the process 400 when the vehicle 101 is at a destination and has shut down. If the first computer 105 determines to continue, the process 500 returns to the block 405. Otherwise, the process 400 ends.

As used herein, the adverb “substantially” modifying an adjective means that a shape, structure, measurement, value, calculation, etc. may deviate from an exact described geometry, distance, measurement, value, calculation, etc., because of imperfections in materials, machining, manufacturing, data collector measurements, computations, processing time, communications time, etc.

Computers 105, 110 generally each include instructions executable by one or more computing devices such as those identified above, and for carrying out blocks or steps of processes described above. Computer executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in the computers 105, 110 is generally a collection of data stored on a computer readable medium, such as a storage medium, a random access memory, etc.

A computer readable medium includes any medium that participates in providing data (e.g., instructions), which may be read by a computer. Such a medium may take many forms, including, but not limited to, non volatile media, volatile media, etc. Non volatile media include, for example, optical or magnetic disks and other persistent memory. Volatile media include dynamic random access memory (DRAM), which typically constitutes a main memory. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in the process 400, one or more of the steps could be omitted, or the steps could be executed in a different order than shown in FIG. 4. In other words, the descriptions of systems and/or processes herein are provided for the purpose of illustrating certain embodiments, and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

The article “a” modifying a noun should be understood as meaning one or more unless stated otherwise, or context requires otherwise. The phrase “based on” encompasses being partly or entirely based on.

What is claimed is:

1. A system, comprising a first computer including a processor and a memory, the memory storing instructions executable by the processor to:
receive a message from a second computer indicating one of a cleaning command specifying a sensor and a precipitation condition;
if the message does not indicate a precipitation condition, actuate a reservoir pump to clean the sensor specified in the cleaning command; and
if the message does indicate the precipitation condition, actuate a windshield wiper.

2. The system of claim 1, wherein the instructions further include instructions to open a valve in fluid communication with the reservoir pump for a period of time specified in the cleaning command.

3. The system of claim 1, wherein the instructions further include instructions to open a valve in fluid communication with an air compressor for a period of time specified in the cleaning command.

4. The system of claim 1, wherein the instructions further include instructions to, upon actuating the windshield wiper, actuate an air compressor to direct air to a sensor.

5. The system of claim 1, wherein the cleaning command includes instructions to actuate the reservoir pump for each of a plurality of specified sensors to spray a fluid onto the specified sensors.

6. The system of claim 1, wherein the instructions further include instructions to, upon completing the cleaning command, send a message to the second computer to determine whether the specified sensor is clean.

7. The system of claim 1, wherein the instructions further include instructions to, upon actuating the windshield wiper, send a message to the second computer to determine whether the precipitation condition has ended.

8. The system of claim 1, wherein the instructions further include instructions to deactivate the windshield wiper upon receiving a second message from the second computer indicating that the precipitation condition has ended.

9. The system of claim 1, wherein the cleaning command includes instructions to actuate the reservoir pump on a first sensor, actuate an air compressor on the first sensor, actuate the reservoir pump on a second sensor, and actuate the air compressor on the second sensor.

10. The system of claim 1, wherein the instructions further include instructions to open a plurality of air manifolds, each air manifold directed to one of a plurality of sensors, and to actuate an air compressor to blow air through the plurality of air manifolds.

11. A system, comprising:
a windshield wiper;
a rain sensor;
a reservoir pump;
means for receiving a message indicating one of a cleaning command specifying a sensor and a precipitation condition;
means for actuating the reservoir pump and the windshield wiper to clean the sensor specified in the cleaning command if the message does not indicate a precipitation condition; and
means for actuating the windshield wiper if the message does indicate the precipitation condition.

12. The system of claim 11, further comprising means to open a valve in fluid communication with the reservoir pump for a period of time specified in the cleaning command.

13. The system of claim 11, further comprising means to open a valve in fluid communication with an air compressor for a period of time specified in the cleaning command.

14. The system of claim 11, further comprising means to, upon actuating the windshield wiper, actuate an air compressor to direct air to a sensor.

15. The system of claim 11, wherein the cleaning command includes instructions to actuate the reservoir pump for each of a plurality of specified sensors to spray a fluid onto the specified sensors.

16. The system of claim 11, further comprising means for, upon completing the cleaning command, sending a message to determine whether the specified sensor is clean.

17. The system of claim 11, further comprising means for, upon actuating the windshield wiper, sending a message to determine whether the precipitation condition has ended.

18. The system of claim 11, further comprising means for deactivating the windshield wiper upon receiving a second message indicating that the precipitation condition has ended.

19. The system of claim 11, wherein the cleaning command includes instructions to actuate the reservoir pump on a first sensor, actuate an air compressor on the first sensor, actuate the reservoir pump on a second sensor, and actuate the air compressor on the second sensor.

20. A method, comprising:
receiving a message from a second computer indicating one of a cleaning command specifying a sensor and a precipitation condition;
if the message does not indicate a precipitation condition, actuating a reservoir pump to clean the sensor specified in the cleaning command; and
if the message does indicate the precipitation condition, actuating a windshield wiper.
